(19) United States
(12) Patent Application Publication
(10) Pub. No.: US 2019/0128509 A1
(43) Pub. Date: May 2, 2019

(54) LED-LIGHT

(71) Applicant: LED-Linear GmbH, Neukirchen-Vluyn (DE)

(72) Inventors: Michael KRAMER, Kamp-Lintfort (DE); Peter SCHOEPPER, Issum (DE); Dennis SCHUETTLER, Krefeld (DE); Soeren BLEUL, Duisburg (DE); Carsten Schaffarz, Neukirchen-Vluyn (DE)

(21) Appl. No.: 16/144,573

(22) Filed: Sep. 27, 2018

(30) Foreign Application Priority Data
Sep. 29, 2017 (DE) 102017009152.8

(51) Int. Cl. F21V 19/00; F21V 21/30

(52) U.S. Cl. CPC F21V 19/004; F21Y 2103/10; F21V 21/30

(57) ABSTRACT

The invention relates to an LED luminaire, comprising a longitudinally extending carrier profile (1) having a bottom region (1c) and two legs (1a), which project from the bottom region (1c) and extend at a distance parallel to one another and which each form an outer wall of the carrier profile (1), wherein, in particular, the carrier profile (1) is formed at least in a substantially U-profile-shaped manner by the legs (1a) and the bottom region (1c), an insertion profile (2), which is attached in the carrier profile (1) by way of a preferably releasable snap-fit and/or detent connection, and a plurality of light-emitting diodes (3a), in particular light-emitting diodes (3a) arrayed next to one another in the longitudinal extension direction on a strip-shaped circuit board (3b), which are attached on/in the carrier profile (1) and/or on/in the insertion profile (2), wherein two attachment legs (1b) are disposed in the interior of the carrier profile (1), which extend between the two legs (1a) forming the outer wall and parallel thereto and which are spaced apart from one another, wherein each attachment leg (1b) comprises a fixed end oriented toward the bottom region (1c), and in particular a fixed end attached to the bottom region (1c), and a free end facing away from the bottom region (1c), which has no contact with the legs (1a) forming the outer wall and is movable relative thereto, and, in particular, is movable in the spacing direction between the legs (1a), wherein the releasable snap-fit and/or detent connection is formed between the insertion profile (2) and the two free ends of the attachment legs (1b).

The invention relates to an LED luminaire, comprising a longitudinally extending carrier profile having a bottom region and two legs, which project from the bottom region and extend at a distance parallel to one another and which each form an outer wall of the carrier profile wherein, in particular, the carrier profile is formed at least in a substantially U-profile-shaped manner by the legs and the bottom region, and furthermore comprising an insertion profile, which is attached in the carrier profile by way of a preferably releasable snap-fit and/or detent connection, and furthermore comprising a plurality of light-emitting diodes, in particular light-emitting diodes arrayed next to one another in the longitudinal extension direction on a strip-shaped circuit board, which are attached on/in the carrier profile and/or on/in the insertion profile.

LED luminaires of this type are known in the prior art in a variety of designs.

The legs of the carrier profile are often disposed in relation to the bottom region thereof in such a way that the legs are oriented at a right angle with respect to the bottom region. Even though this design is also preferred for the invention, the invention is not limited thereto. The legs may also be disposed at angles deviating from 90 degrees with respect to the bottom region here, but extend parallel to one another in the longitudinal extension direction.

A common design is such that, for example, the carrier profile is formed by an extruded aluminum profile, to the bottom region of which a preferably flexible LED strip comprising a multitude of LEDs disposed next to one another in a row may be adhesively attached.

In the prior art, the insertion profile is commonly formed by a translucent cover, which closes the carrier profile, comprising the LED strip present therein, in a manner that allows light to pass.

In other known embodiments, it may also be provided that the LEDs, in particular LEDs arrayed on a strip-shaped, and preferably flexible, circuit board, are disposed on, or in, the insertion profile.

In particular, in a first embodiment, it is known to form a snap-fit or detent connection between the free ends of the legs forming the outer wall and the insertion profile. This may also be the case in a second embodiment; however, embodiments in which the bottom of the insertion profile is joined to the bottom of the carrier profile by latching engagement are also known.

Both designs, in principle, have in common that, during assembly, the carrier profile is initially attached to a mounting subsurface, such as a wall or a ceiling. Potential irregularities in the mounting subsurface are generally transferred to the carrier profile in this process.

The snap-fit and/or detent connection formed between the carrier profile and the insertion profile is designed for the two profiles to have an ideal straight longitudinal extension and, in particular, for no torsion to be present in one of the profiles, about the longitudinal direction.

If, after assembly, the progression of the carrier profile is no longer ideal, it is more difficult to join the two profiles since, during attachment, the insertion profile has to be adapted to the non-optimal progression of the carrier profile by the application of a force, so that the correspondingly designed attachment elements in the connection engage one another.

Torsions in the bottom region on the carrier profile, for example, result in the free leg ends of the carrier profile intended for a snap-fit and/or detent connection no longer extending in an ideal manner parallel to one another, in the longitudinal direction, such that the positions of the corresponding attachment elements of the two profiles no longer precisely fit one another.

It is possible that this may still require little effort, for example, if the flexibility of the insertion profile is sufficient, for example if this only represents a translucent cover made of a pliable plastic material.

However, in particular, if the insertion profile also receives the LEDs, this is commonly made of metal, which allows for considerably less bending during assembly. When the bottom regions of the two profiles are joined to one another, as a result of the design, these also form the most flexurally rigid regions of the profile, so that torsions in this area are particularly problematic.

Applying force may thus result in damage. Furthermore, it is possible that the two profiles, after having been joined successfully, are not optimally aligned with one another, which may not be aesthetically pleasing.

If such carrier profiles are moreover plastered with mortar, after curing, the mortar prevents any movement of the carrier profile, which makes it at least more difficult, if not impossible, to insert the insertion profile.

It is thus an object of the invention to provide an LED luminaire of the type mentioned at the outset, which has a higher tolerance in terms of joining the carrier profile and the insertion profile, so that the two profiles can be joined more easily. It is a further object, in particular, to design the carrier profiles so as to be suitable for flush-mounted use.

According to the invention, this object is achieved by disposing two attachment legs in the interior of the carrier profile, which extend between the two legs forming the outer wall p3 parallel thereto and which are spaced apart from one another, wherein each attachment leg comprises a fixed end oriented toward the bottom region, and in particular a fixed end attached to the bottom region, and a free end facing away from the bottom region, which has no contact with the legs forming the outer wall and is movable relative thereto, and in particular, is movable in the spacing direction between the legs, wherein a releasable snap-fit and/or detent connection is formed between the insertion profile and the two free ends of the attachment legs.

The attachment legs preferably have a length, starting from the bottom region, that is less than the length of the legs forming the outer wall, whereby the free ends of the attachment legs are ideally entirely situated inside the carrier profile, which is to say, recede behind the opening plane of the carrier profile. The actual attachment area of the two profiles is thus no longer visible from the outside, in a design where these are later joined.

Furthermore, by virtue of implementation on the inner attachment legs, instead of on the outer legs, the attachment is formed closer to the center longitudinal axis of the carrier profile, so that torsions that occur have less impact than is the case with the free leg ends of the outer legs.

The advantage of insertion profiles that are attached to the attachment legs by way of a region located near the bottom of the insertion profile is that, despite the comparatively high rigidity of the insertion profile in this area, sufficiently high flexibility is provided at the free ends of the inner attachment legs, whereby the attachment of the two profiles is simplified.

Advantageously, the carrier profiles of a luminaire according to the invention may be plastered with mortar. Since the attachment function is exerted by the inner pair of attachment legs, if the cured mortar were to prevent the outer legs from moving, this would have no influence on the attachment, since the inner attachment legs remain movable.

Mechanical forces that act due to the detent function when the insertion profile is inserted into the carrier profile are thus mechanically decoupled from the plaster or mortar layer.

Preferably, the invention may provide that the insertion profile comprises two detent grooves, which extend across the longitudinal extension of the insertion profile and are disposed parallel to one another, and in particular on opposing sides. In this embodiment, it may be provided that the attachment leg ends include detent projections oriented in the direction of the grooves, which engage in the grooves.

In the case of an insertion profile that is formed by a U-shaped profile, or at least comprises such a profile, the detent grooves can thus be disposed on the outside of the legs of the U-shaped profile.

Preferably, each detent groove can be open in the direction of a nearby adjoining attachment leg, wherein a corresponding detent projection at the free end of the respective nearby attachment leg engages in each of the detent grooves.

It is likewise possible to provide projections extending in the longitudinal direction on the insertion profile, which, in particular, are outwardly oriented, and corresponding detent grooves on the free leg ends, which, in particular, are open to the inside.

According to the invention, the snap-fit and/or detent connection between the insertion profile and the two free ends of the attachment legs is preferably the only attachment that secures the insertion profile to prevent removal from the carrier profile. Particularly preferably, it may be provided that the free ends of the legs of the carrier profile either have no contact whatsoever with the insertion profile or, if contact is made, rest only loosely against the insertion profile. Preferably, resting loosely shall be understood to mean that no retaining force that counteracts a release of the insertion profile and carrier profile is exerted by the contact.

In a design that is completely contact-free, the invention may provide that a shadow gap is formed between the free ends of the leg of the carrier profile and the insertion profile. This has the advantage that, even though the shadow gap may not be exactly even, if assembly-induced torsion occurs, this will not be noticeable, or at the most will be minimally noticeable, to the human eye, so that the provision of such a shadow gap can visually conceal such inaccuracies that occur.

In particular, in applications where shadow gaps are not desirable, the invention can also provide that the insertion profile at least partially covers the end faces of the legs of the carrier profile on the light emission side. This makes it possible for such an at least partial coverage to be present at all times should torsions occur, even if the progression of the profile deviates from the ideal line, so that no gap is visible to the view of the observer, and the appearance is harmonious, even if assembly is not ideal.

In particular, in the case of only partial coverage, the design here can provide that a surface region of the insertion profile is located in the same plane with the edge of the legs ends, which is located the furthest to the outside in the light emission direction, and in particular leg ends that are tapered in the light emission direction. So as to form such a taper, the leg ends may include a chamfer, for example. This chamfered area of the leg ends may be located opposite a corresponding chamfer of the insertion profile and may be at least partially covered thereby.

According to one possible embodiment of the invention, the insertion profile can form a translucent, and in particular opaque, cover of the interior of the carrier profile. In this embodiment, but also in other embodiments of the insertion profile, the light-emitting diodes of the LED luminaire according to the invention can be disposed on the carrier profile, for example on the bottom region thereof. The light-emitting diodes can also be attached on/in the insertion profile.

An insertion profile designed as a cover can be designed, for example, as a profile that has a U-shaped cross-section and is open toward the bottom region of the carrier profile, the legs of the profile being located on the inside between the attachment legs.

In this embodiment, the carrier profile and the insertion profile thus each have a U-profile shape, having opposite opening directions.

Here, light-emitting diodes may be attached, for example, to the cover between the legs thereof, such as on the inner surface of the region connecting the legs or, as mentioned above, to the bottom of the carrier profile.

An insertion profile can also include a bottom region having legs that laterally adjoin the bottom region and project therefrom, whereby, in particular, a U profile shape of the insertion profile is formed at least near the bottom region, wherein the interior of the insertion profile is open in the same direction as the interior of the carrier profile, and a plurality of light-emitting diodes are disposed in the interior of the insertion profile.

In this embodiment, for example, the outer surface of the bottom of the insertion profile can make contact with the inner surface of the bottom of the carrier profile after insertion, or can be disposed at a distance near this bottom. Such an insertion profile can be open toward the outside, in particular in the light emission direction of the light-emitting diodes disposed in the insertion profile.

The insertion profile, in contrast, can also be closed on all sides, or can be closed except for the end faces located in the longitudinal extension direction.

For example, such an insertion profile may include a U-shaped profile, which is disposed in the carrier profile so that the interior thereof, assuming that it is not closed, is open in the same direction as the carrier profile. Such a U-shaped profile of the insertion profile may be closed by a lid, so that the lid and the U-shaped profile together form the insertion profile. The lid of the insertion profile can be attached to the free leg ends of the U-shaped profile of the insertion profile by way of a snap-fit and/or detent connection. If necessary, only the lid of the insertion profile located in the light emission direction can have a translucent and/or opaque design.

Compared to the aforementioned orientation of the U-shaped profile, the insertion profile closed by a lid can also be attached in the carrier profile rotated by 180 degrees about the longitudinal axis. In this case, at least the bottom of the insertion profile, which is to say the region between the legs of the U-shaped profile, or at least the entire U-shaped profile, has a translucent and/or opaque design. The lid assigned to the bottom of the carrier profile can carry the light-emitting diodes on the inside and can be either translucent and/or opaque or impervious to light.

The light-emitting diodes disposed in the interior of the insertion profile or the carrier profile can be arrayed next to one another in the longitudinal direction in any possible design, for example on a strip-shaped circuit board, and in particular a flexible circuit board.

In the aforementioned embodiments of an insertion profile, or in other embodiments not described, the invention can provide that the detent and/or snap-fit connection between the insertion profile and the carrier profile is formed at a height above the bottom region of the carrier profile which is greater than 50% of the total height of the legs forming a respective outer wall, measured between the bottom region of the carrier profile and the upper free ends of the legs thereof.

The invention can also provide that the snap-fit and/or detent connection between the free ends of the attachment legs and the insertion profile, in particular the legs of an insertion profile comprising a U-shaped profile, and preferably the fixed ends of the legs adjoining the bottom region, is formed at a height above the bottom region of the carrier profile which is less than 50% of the total height of the legs of the carrier profile forming a respective outer wall, measured between the bottom region of the carrier profile and the upper free ends of the legs.

All types of attachment and configuration of the insertion profile can provide that, after being attached in the carrier profile, this does not protrude beyond the opening plane of the carrier profile, and in particular that which is defined by the upper edges of the two legs thereof.

In all possible embodiments, the invention can furthermore provide that a leg of the carrier profile forming a respective outer wall, seen in a cross-section perpendicular to the longitudinal extension direction thereof, has a curved progression, and in particular a circular segment-shaped curved progression, in the direction of the opposing leg of the carrier profile, at the respective free end region or end region located in the light emission direction.

In particular with such a progression, but also with other design configurations, the invention can provide that the free end of a leg of the carrier profile forming a respective outer wall is offset with respect to the fixed end of the same leg, and preferably offset in the direction of the opposing leg, which is to say, in particular in the direction of the spacing of the two legs or, in the understanding of a person skilled in the art, in the width direction of a luminaire. This can also be achieved, for example, by a progression of a leg that, seen in the cross-section perpendicular to the longitudinal extension, is rectilinear, but deviates 90 degrees from the bottom region and is inclined with respect to the opposing leg.

Such an offset can preferably cause the free end of a respective leg of the carrier profile to be disposed above the free end of an attachment leg located on the inside next to this. The arrangement of the leg ends on top of one another can be such that, for example, the surface of an upper end of a leg of the carrier profile which is oriented toward the interior of the carrier profile is arranged in alignment, in the vertical direction, with the inwardly oriented surface of an attachment leg.

Due to the inward offset of the free end of the respective leg of the carrier profile in the direction of the opposing leg, which is implemented, for example, by the aforementioned curved progression or an inclination of the leg, a surface area is implemented on the respective leg, comprising mortar which can, for example, be plastered with mortar, namely the outer surface region of the aforementioned curvature, for example, or of an inclined leg as a whole, generating an undercut region in the cured mortar, whereby the luminaire according to the invention is integrated particularly well into the mortar.

In one possible embodiment of the insertion profile, it may also be provided that this includes a bottom region having legs that laterally adjoin the bottom region and project therefrom, whereby, in particular, a U profile shape of the insertion profile is formed, at least near the bottom region and, essentially as described above, in particular, no lid is provided in this embodiment.

The interior of the insertion profile can be open in the same direction here as the interior of the carrier profile, and a plurality of light-emitting diodes can be disposed in the interior of the insertion profile, wherein the snap-fit and/or detent connection is formed between the free ends of the attachment legs in the carrier profile and the legs of the insertion profile, and preferably on the fixed ends of the legs of the insertion profile which adjoin the bottom region thereof.

The invention can provide here that an LED luminaire body, which comprises light-emitting diodes, and in particular light-emitting diodes arrayed, as described above, on the circuit board strip in the longitudinal direction, is in turn inserted into such an insertion profile.

In this embodiment, the LED luminaire body is thus held indirectly in the carrier profile by way of the insertion profile, which, in particular, can create a further tolerance range in the connection of the components, since the insertion profile is attached to the movable ends of the attachment legs of the carrier profile, and the LED luminaire body is attached to the likewise movable legs of the insertion profile.

Here, a particularly preferred embodiment may provide that the LED luminaire body is held rotatably, and preferably held infinitely rotatably, about the longitudinal extension direction in the insertion profile by the legs of the insertion profile. Rotation of the LED luminaire body may furthermore preferably be inhibited by frictional engagement between the mutually contacting surfaces of the LED luminaire body and the legs of the insertion profile. An LED luminaire body can thus be rotated about the longitudinal direction and is held in a self-locking manner in every selected rotational position.

For this purpose, the outer cross-section of the LED luminaire body can have a circular segment-shaped design, seen perpendicularly to the longitudinal extension, and in particular a circular segment-shaped design by more than 200 degrees.

The invention can provide here that, seen in the cross-section perpendicular to the longitudinal extension direction, the distance of the legs of the insertion profile initially increases, and thereafter decreases, in the direction of the free leg ends, in a region of the insertion profile intended to receive the LED luminaire body. In this way, it is achieved that the legs of the insertion profile hold and surround the LED luminaire body.

For this purpose, for example, the progression of the legs from the fixed to the free end can be polygonal, and particularly preferably, in this region, the mutually facing leg surfaces can have a circular segment-shaped design, in particular having a circular segment diameter that corresponds to the circular segment diameter of the LED luminaire body having a corresponding circular segment-shaped cross-section, in particular so that the circular segment-shaped surfaces of the legs enclose the circular segment-shaped surfaces of the LED luminaire body in a form-fit manner.

In a refinement for all possible embodiments, it may be provided that longitudinally extending energized contact strips, which are recessed in longitudinal grooves, are disposed on the inside on the bottom region of the carrier profile between the attachment legs, opposing sliding contacts on the insertion profile making contact with these contact strips, which are preferably disposed in longitudinal grooves on the outside, on the bottom of the insertion profile, wherein the sliding contacts of the insertion profile make electrical contact with the light-emitting diodes of the LED luminaire body.

The longitudinal grooves of the energized contact strips can be disposed in a strip element that is separate from the carrier profile, for example, which is inserted into the carrier profile between the attachment legs thereof.

In all embodiments of the LED luminaire according to the invention, the entire luminaire can be designed so as to be plastered with mortar and/or so as to be suitable for ceiling/wall cavity construction.

For example, tabs, which protrude outwardly in the direction of the spacing between the legs and extend across the longitudinal direction of the carrier profile, can be disposed in the region of the free ends of the legs of the carrier profile, at a distance from the end face of the legs of carrier profile on the light emission side. These can be located in a plane parallel to, and at a distance from, the bottom plane of the carrier profile, and form surfaces that can be plastered with mortar.

The distance between the upper faces of the tabs and the end face of the leg ends of the carrier profile on the light emission side can be dimensioned so as to correspond to a customary thickness of a trowel-applied coating, which is applied, for example, to customary drywall panels, made of gypsum, for example, thus in particular 1 to 3 mm.

The invention can also provide that, in the direction of the spacing of the legs, the width of the bottom region of the carrier profile is greater than the distance between the legs forming the outer wall, whereby the bottom region forms tabs that protrude from the legs and can be plastered with mortar, in particular having a structured, and preferably grooved, surface. The height of the free ends of the legs of the carrier profile above the upper face of the tabs corresponds to a thickness of a mortar layer, into which this profile can be integrated by plastering. This height is preferably less than 15 mm, and more preferably less than or equal to 10 mm.

Embodiments of the invention will be described in more detail based on the figures.

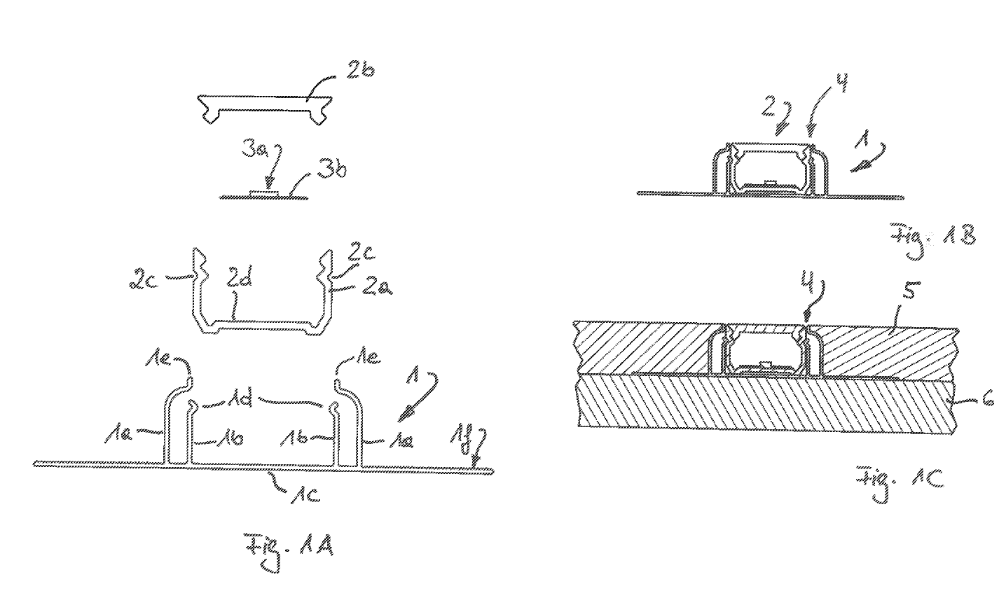

FIGS. 1A, 1B and 1C show several views of a first possible embodiment of a luminaire according to the invention in a cross-section perpendicular to the longitudinal extension direction of the luminaire. End caps of the luminaire, which may possibly be inserted on the end faces, are not shown. The illustrated cross-section is thus identical across the entire longitudinal extension at least between such potentially provided end caps.

The luminaire comprises a carrier profile 1, an insertion profile 2 composed of the sub-elements 2a and 2b, and an array 3 of a plurality of light-emitting diodes 3a, which are arrayed next to one another in the longitudinal extension direction on a preferably flexible strip-shaped circuit board 3b.

The carrier profile comprises two spaced legs 1a that extend parallel to one another and form two outer walls of the carrier profile 1, or of the entire luminaire. In the interior of the carrier profile 1, two spaced attachment legs 1b are provided, which extend parallel to these legs 1a and the height of which above the bottom region 1c is less than the height of the legs 1a.

The upper free ends of the attachment legs 1b comprise inwardly oriented detent projections 1d, which are provided to engage in corresponding detent grooves 2c on the insertion profile 2.

The upper free ends 1e of the legs 1a are each inwardly offset, in the direction of the opposing leg 1a, with respect to the ends of the legs 1a fixed to the bottom region, and here are disposed above the free ends 1d of the attachment legs 1b. The offset here is implemented by a progression of the legs 1a that, in the region in front of the free ends 1e, is initially curved in a circular segment-shaped manner in the direction of the opposing leg 1a, preferably curved by 90 degrees here, and thereafter is upwardly bent so as to form a free end 1e, which extends in a parallel offset manner on the last portion of the extension thereof in relation to the lower region of the leg 1a.

The lower part 2a of the insertion profile 2 has a substantially U-shaped design here, and is open in the same direction of the light emission direction as the carrier profile, which likewise essentially describes a U shape with the bottom region 1c between the legs 1a and the legs 1a.

The LED array 3 is attached to the bottom 2d of the insertion profile 2, and the lower part 2a is closed by a lid 2b. At least the lid 2b is translucent. The inside of the insertion profile 2 can be potted in a waterproof manner, for example, with a potting compound.

It is apparent that the connection between the insertion profile 2 and the carrier profile 1 is only achieved by the latching engagement between the upper ends 1d of the attachment legs and the detent grooves 2c of the insertion profile. This latching engagement is positioned at a height above the bottom region 1c which is greater than 50% of the height of the legs 1a above the bottom region 1c. To the extent that the free ends 1e of the legs 1a rest against the insertion profile 2, these are only in loose contact with the insertion profile and thus perform no retaining function whatsoever.

The legs 1a thus cover the attachment locations between the two profiles. Due to the flexibility of the free ends 1d in the spacing direction of the legs, simple attachment of the profiles among one another is achieved, even if, due to the mounting circumstances, the carrier profile does not always have the ideal rectilinear progression. The free ends of the outer legs 1a are able to adapt to the progression of the insertion profile 2 without difficulty, in particular when these make contact with the insertion profile. As an alternative, these may also form a shadow gap 4, which has a visually appealing upper face, at a distance from the insertion profile.

If contact exists between the free ends 1e and the insertion profile 2, the invention, in the embodiment described here, but also in all other embodiments described in the general part, or in embodiments not mentioned, can provide that the inner surfaces of the free ends 1e of the legs 1a are aligned with the inner surfaces of the attachment legs 1b in the vertical direction, at least after the two profiles have been attached to one another. Such an aligned arrangement can also be present when the insertion profile is not yet mounted in the carrier profile.

As an alternative, the offset of the free ends 1e can be selected so that the distance between the free ends 1e of the opposing legs 1a is smaller than the width of the insert, and in particular also smaller than the distance between the attachment legs, so that the free ends 1e rest laterally against the insertion profile when the insertion profile 2 is attached in the carrier profile 1 using a pressing force, and close a possibly present gap 4. It is thus possible to define whether a shadow gap 4 is created between the insertion profile 2 and the carrier profile 1, or whether such a gap 4 is reliably closed, based on the magnitude of the offset of the free ends 1e in relation to the fixed ends and/or the distance between the free ends 1e.

According to FIG. 10, it is apparent that the tabs if laterally adjoining the bottom region 1c on both sides of the legs 1a, which have a corrugation on the upper face here, can be plastered with mortar 5, which also coats the curved outer surface of the legs 1a, and thus reliably encloses the luminaire as a whole.

The height of the legs 1a is selected here so as to correspond to a desired or customary mortar thickness above an assembly substrate 6, for example preferably less than 20 mm, more preferably less than 15 mm, and more preferably less than or equal to 10 mm.

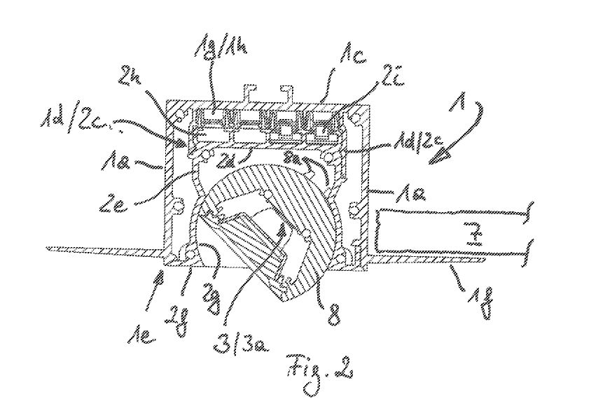

FIG. 2 shows another embodiment of the invention. Again, the carrier profile 1 includes a bottom region 1c and legs 1a extending away therefrom, which essentially define a U profile shape of the carrier profile 1.

Tabs 1f are disposed at the free ends 1e of these legs 1a at a slight distance from the leg end 1e, and at a greater distance from the bottom region 1c, and can be placed on drywall elements 7 and covered with plaster, up to the leg end 1e. In this way, a carrier profile of this nature can be easily used in cavity ceiling or wall construction.

Here as well, the carrier profile 1, on the inside, comprises two attachment legs 1b that are disposed at a distance and extend parallel, and that include detent projections 1d, which are provided to engage in detent grooves 2c on the insertion profile 2.

In the attachment leg 1b that is designed longer on the right than on the left here, as well, the detent projection 1d is understood to be disposed on the free end, namely within the meaning that the free end is a movable region of the attachment leg 1b, which is disposed at a distance from the fixed end thereof on the bottom region 1c.

The insertion profile 2 also has a U-shaped profile, similarly to the carrier profile, and is open in the same direction. This includes a bottom 2d, from which legs 2e extend. The free ends 2f form a surface area that, by way of a lateral chamfer, at least partially covers a chamfered region of the leg ends 1e of the carrier profile. Potential inaccuracies in the progression between the profiles 1 and 2 can be concealed by this coverage.

This particular design of the luminaire shows that an LED luminaire body 8 is received in the insertion profile and between the legs 2e thereof, which LED comprises an LED array 3 and is held rotatably about the longitudinal axis thereof, which is perpendicular to the drawing plane, between the legs 3e.

For this purpose, the LED luminaire insert 8 has a circular segment-shaped cross-sectional shape over more than 180 degrees, and preferably more than 200 degrees. With a respective corresponding circular segment-shaped region 2g, the legs 2e of the insertion profile 2 engage on the outer circular segment surface of the LED luminaire insert 8 in a form-fit manner.

FIG. 2 further shows that the bottom region 1c between the legs 1a includes longitudinal grooves 1g on the inside, in which longitudinally extending energized contacts 1h are disposed. Opposite thereto, the bottom 2d of the insertion profile includes corresponding grooves 2h, in which sliding contacts 21 are disposed, which supply the LED array 3 with power via cables. In this way, electrical contact can thus be directly established by attaching the insertion profile in the carrier profile. A preassembled unit comprising the insertion profile 2 and the LED luminaire body 8 can thus be inserted into the carrier profile 1 and put into operation.

It may be provided that the carrier profile 1 has a greater length than a unit comprising the insertion profile 2 and the LED luminaire body 8. In this way, multiple units 2/8 may be inserted into a carrier profile 1, having a light emission direction that can be adjusted differently in the same carrier profile 1 by way of the rotatability of the luminaire body 8.

The LED luminaire bodies 8 can comprise stops 8a on the rear, which is to say facing away from the light emission direction, so that the range of the rotational angle is limited, and the luminaire bodies 8 are not inadvertently disengaged from the legs 2e by rotating too far.

1. An LED luminaire, comprising:
a. a longitudinally extending carrier profile having a bottom region and two legs which project from the bottom region and are spaced from one another and extend parallel to one another, and which each form an outer wall of the carrier profile, wherein, the carrier profile has a U-shaped cross-section formed by the legs and the bottom region;
b. an insertion profile which is attached in the carrier profile; and
c. a plurality of light-emitting diodes which are attached to at least one of the carrier profile and the insertion profile,
wherein
two attachment legs are disposed in an interior of the carrier profile, the two attachment legs are spaced from one another and extend between the two legs forming the outer wall and parallel thereto,
each of the attachment legs comprises a fixed end oriented toward the bottom region and attached to the bottom region, and a free end facing away from the bottom region and having no contact with the legs forming the outer wall and being movable relative to the legs forming the outer wall in a direction in which the legs forming the outer wall are spaced from one another, and
a releasable snap-fit or detent connection is formed between the insertion profile and the two free ends of the attachment legs.

2. The LED luminaire according to claim 1, wherein
the detent connection comprises two detent grooves in the insertion profile, and the two grooves extend in the longitudinal direction of the insertion profile and are disposed parallel to one another on opposing sides of the insertion profile, and
each detent groove is open in a direction of a respective one of the attachment legs which is nearby the detent groove, and,
a corresponding detent projection at the free end of the respective nearby attachment leg engages in each of the detent grooves.

3. The LED luminaire according to claim 1, wherein the snap-fit and/or detent connection between the insertion profile and the two free ends of the attachment legs is the only attachment that secures the insertion profile to prevent removal thereof from the carrier profile, the free ends of the legs of the carrier profile having no contact with the insertion profile or resting only loosely thereagainst.

4. The LED luminaire according to claim 1, wherein
ends of the legs of the carrier profile taper in a light emission direction of the luminaire and the insertion profile partially covers end faces of the legs of the carrier profile on the light emission side, a surface region of the insertion profile being located in a same plane as an edge of the legs ends which is located the furthest on the outside in the light emission direction.

5. The LED luminaire according to claim 1, wherein the light emitting diodes are attached to the insertion profile and the insertion profile forms a translucent opaque cover of an interior space of the carrier profile.

6. The LED luminaire according to claim 1, wherein
the insertion profile has a U-shaped cross-section and is open toward the bottom region of the carrier profile, legs of the insertion profile being located within the carrier profile, between the legs of the carrier profile, and the light-emitting diodes are attached to the cover between the legs of the insertion profile.

7. The LED luminaire according to claim 1, wherein the insertion profile includes a bottom region having legs that laterally adjoin the bottom region and project therefrom, whereby a U profile shape of the insertion profile is formed at least near the bottom region, wherein an interior of the insertion profile is open in a same direction as an interior of the carrier profile and a plurality of light-emitting diodes are disposed in the interior of the insertion profile.

8. The LED luminaire according to claim 1, wherein the detent and/or snap-fit connection between the insertion profile and the carrier profile is formed at a height above the bottom region of the carrier profile which is greater than 50% of the total height of the legs of the carrier profile, measured between the bottom region of the carrier profile and the free ends of the legs.

9. The LED luminaire according to claim 6, wherein the snap-fit and/or detent connection between the free ends of the attachment legs and the insertion profile is with fixed ends of the legs of the insertion profile adjoining the bottom region and is formed at a height above the bottom region of the carrier profile which is less than 50% of the total height of the legs of the carrier profile, measured between the bottom region of the carrier profile and the free ends of the legs.

10. The LED luminaire according to claim 1, wherein each leg of the carrier profile, seen in the cross-section perpendicular to the longitudinal direction of the carrier profile, has a curved progression in a direction of the opposing leg of the carrier profile, at a respective upper end of each of the legs of the carrier profile.

11. The LED luminaire according to claim 10, wherein the curved progression offsets a free end of each of the legs of the carrier profile perpendicularly to the longitudinal direction of the carrier profile with respect to a fixed end of that leg of the carrier profile, and the free end of each of the legs of the profile is disposed above the free end of a respective one of the attachment legs.

12. The LED luminaire according to claim 11, wherein a surface of the free end of each of the legs of the carrier profile, which is oriented toward an interior of the carrier profile, is arranged in alignment, in a vertical direction, with an inwardly oriented surface of a respective one of the attachment legs.

13. The LED luminaire according to claim 6, wherein an LED luminaire body is disposed in the insertion profile and is held, by the legs of the insertion profile, rotatably about an axis extending in a longitudinal direction of the LED luminaire, rotation of the LED luminaire body being inhibited by frictional engagement between mutually contacting surfaces of the LED luminaire body and the legs of the insertion profile.

14. The LED luminaire according to claim 13, wherein, viewed as a cross-section perpendicular to the longitudinal direction of the insertion profile, distance between the legs of the insertion profile initially increases, and thereafter decreases, in a direction of free ends of the legs of the insertion profile, in a region configured to receive the LED luminaire body, in which region mutually facing surfaces of the insertion profile have a polygonal or a circular segment-shaped configuration, wherein diameter of the circular segment shaped surface of the insertion profile corresponds to diameter of the circular segment shaped surface of the LED luminaire body so that the circular segment-shaped surfaces of the legs of the insertion profile enclosed the LED luminaire body in a form-fit manner.

15. The LED luminaire according to claim 1, wherein longitudinally extending contact strips, which are recessed in longitudinal grooves, are disposed inside the carrier profile on the bottom region of the carrier profile between the attachment legs, sliding contacts on the insertion profile making contact with the contact strips, the sliding contacts being disposed in grooves on an outside of the insertion profile at a bottom of the insertion profile, the sliding contacts of the insertion profile making electrical contact with the light-emitting diodes of the LED luminaire body.

16. The LED luminaire according to claim 15, wherein the longitudinal grooves in which the contact strips are disposed are situated in a strip element that is separate from the carrier profile and which is inserted into the carrier profile between the attachment legs thereof.

17. The LED luminaire according to claim 1, wherein outwardly protruding longitudinally extending tabs are disposed in a region of the free ends of the legs of the carrier profile at a distance from an end face of the free end of each of the legs of the carrier profile on a light emission side of the LED luminaire, the tabs being located in a plane parallel to, and at a distance from, the bottom plane of the carrier profile and forming surfaces that can be plastered with mortar.

18. The LED luminaire according to claim 1, wherein, in a direction of the spacing from one another of the legs of the carrier profile, a width of the bottom region of the carrier profile is greater than a distance from one another of the legs of the carrier profile whereby the bottom region of the carrier profile forms tabs that protrude from the legs and can be plastered with mortar.

19. The LED luminaire according to claim 1, wherein
the plurality of light emitting diodes are arrayed next to one another, on a strip-shaped circuit board, in a longitudinal direction of the LED luminaire.

20. The LED luminaire according to claim 18, wherein the tabs have a grooved surface.
